(19) United States
(12) Patent Application Publication
(10) Pub. No.: US 2009/0133554 A1
(43) Pub. Date: May 28, 2009

(54) METHOD FOR DETECTING WHETHER OBJECT IS COMPLETELY CUT OFF AND CUTTING DEVICE USING SUCH METHOD

(75) Inventor: Yung-Tai Pan, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/106,746

(22) Filed: Apr. 21, 2008

(30) Foreign Application Priority Data
Nov. 23, 2007 (TW) 096144393

(51) Int. Cl. B23Q 15/007; B26D 1/00

(52) U.S. Cl. 83/72; 83/13

(57) ABSTRACT

The present invention relates to a method for detecting whether an object is completely cut off and a cutting device using such a method. The cutting device includes a cutter frame, a blade, a conductive platform and an electric-conduction status detecting unit. The electric-conduction status detecting unit can detect the electric-conduction status between the blade and the conductive platform to discriminate whether the object on the conductive platform is completely cut off by the blade.

### FIELD OF THE INVENTION

The present invention relates to a cutting method and a cutting device, and more particularly to a cutting method and a cutting device capable of detecting whether an object is completely cut off.

### BACKGROUND OF THE INVENTION

Conventionally, the cutting device for cutting sheet articles such as papers, photographs or the like commonly uses a cutting mechanism to perform the cutting operation. After the sheet article to be cut is placed on the platform of the cutting device, the blade is moved back and forth to cut off the object into two parts. In addition, the cutting device can be integrated into an apparatus with a paper-transfer mechanism (e.g. a facsimile machine or an automatic document feeder) for cutting the exited paper into desired size.

As known, the conventional cutting device lacks a mechanism for discriminating whether the object is completely cut off. In a case that the cutting operation is terminated before the object is completely cut off, the cutting performance is not satisfactory. Whereas, in another case that the cutting operation is continuously proceeding after the object has been completely cut off, the platform is readily suffered from abrasion and more power is consumed.

Therefore, there is a need of providing a cutting device having a mechanism for detecting whether the object or objects have been completely cut off. Especially when a stack of paper sheets or a stack of photographs are simultaneously placed on the platform, the mechanism for detecting whether the object or objects have been completely cut off becomes more important. Since several cutting cycles are often required to completely cut off the stack of paper sheets or photographs, the detecting mechanism may prevent from over-cutting or under-cutting the objects.

### SUMMARY OF THE INVENTION

It is an object of the present invention to provide a method for detecting whether an object is completely cut off and a cutting device using such a method so as to prevent from over-cutting or under-cutting the object.

In accordance with an aspect of the present invention, there is provided a cutting device. The cutting device includes a cutter frame, a blade, a conductive platform, a power source and an electric-conduction status detecting unit. The cutter frame is movable between a first returning point and a second returning point. The blade is mounted on the cutter frame and partially protruded from a bottom of the cutter frame. The conductive platform is disposed under aid cutter frame for supporting an object to be cut by the blade. The power source has a first terminal coupled to the blade and a second terminal coupled to the conductive platform. The electric-conduction status detecting unit is used for detecting whether the blade and the conductive platform are electrically connected to each other.

In an embodiment, the electric-conduction status detecting unit includes a current detector for detecting a current when the blade is contacted with the conductive platform.

In an embodiment, the electric-conduction status detecting unit includes a light emitting diode for asserting an optical signal when the blade is contacted with the conductive platform.

In an embodiment, the electric-conduction status detecting unit includes a voltage detector for detecting a first voltage when the object is not completely cut off by the blade or detecting a second voltage when the blade is contacted with the conductive platform.

In an embodiment, the cutting device further includes a driving unit for driving the cutter frame.

In an embodiment, the cutting device further includes a first position detector at the first returning point. The first position detector asserts a first sensing signal to the driving unit when the cutter frame is located at the first returning point. In response to the first sensing signal, the driving unit drives the cutter frame to move from the first returning point toward the second returning point.

Preferably, the first position detector is a limit switch.

In an embodiment, the cutting device further includes a second position detector at the second returning point. The second position detector asserts a second sensing signal to the driving unit when the cutter frame is located at the second returning point. In response to the second sensing signal, the driving unit drives the cutter frame to move from the second returning point toward the first returning point.

Preferably, the second position detector is a limit switch.

In accordance with another aspect of the present invention, there is provided a method for detecting whether an object is completely cut of by a cutting device. The cutting device includes a cutter frame, a blade mounted on the cutter frame and a conductive platform for supporting an object to be cut by the blade. The cutter frame is movable between a first returning point and a second returning point to have the blade cut off the object. Firstly, a first terminal of a power source is coupled to the blade. Then, a second terminal of a power source is coupled to the conductive platform. Then, whether the blade is electrically connected with the conductive platform is detected. If the blade is continuously electrically connected with the conductive platform during the cutter frame is moved from the first returning point to the second returning point, it is discriminated that the object has been completely cut off.

In an embodiment, the method further comprises a step of discriminating that the object has not been completely cut off if the blade is not continuously electrically connected with the conductive platform during the cutter frame is moved from the first returning point to the second returning point.

In an embodiment, the step of detecting whether the blade is electrically connected with the conductive platform is implemented by an electric-conduction status detecting unit.

In an embodiment, the electric-conduction status detecting unit includes a current detector for detecting a current when the blade is contacted with the conductive platform.

In an embodiment, the electric-conduction status detecting unit includes a light emitting diode for asserting an optical signal when the blade is contacted with the conductive platform.

In an embodiment, the electric-conduction status detecting unit includes a voltage detector for detecting a first voltage when the object is not completely cut off by the blade or detecting a second voltage when the blade is contacted with the conductive platform.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram of a cutting device according to a first preferred embodiment of the present invention;

FIG. 2 is a schematic side view of the cutting device shown in FIG. 1;

FIG. 3A and FIG. 3B are schematic circuit diagrams illustrating a method for detecting whether an object is completely cut off by means of a light emitting diode;

FIG. 4 is a schematic functional block diagram of a cutting device according to a second preferred embodiment of the present invention;

FIG. 5 is a schematic side view of the cutting device shown in FIG. 4;

FIG. 6A and FIG. 6B are schematic circuit diagrams illustrating a method for detecting whether an object is completely cut off by means of a current detector; and

FIGS. 7A, 7B and 7C are timing diagrams illustrating current measured by the current detector in the second preferred embodiment of the present invention

### DETAILED DESCRIPTION OF THE PREFERRED EMBODIMENT

For obviating the drawbacks encountered from the prior art, the present invention provides a method for detecting whether an object is completely cut off and a cutting device using such a method so as to prevent from over-cutting or under-cutting the object. In accordance with a key feature of the present invention, the cutting operating is automatically terminated or a complete cut-off signal is asserted to notify the user when the mechanism detects that the object is completely cut off, thereby preventing from over-cutting or under-cutting the object.

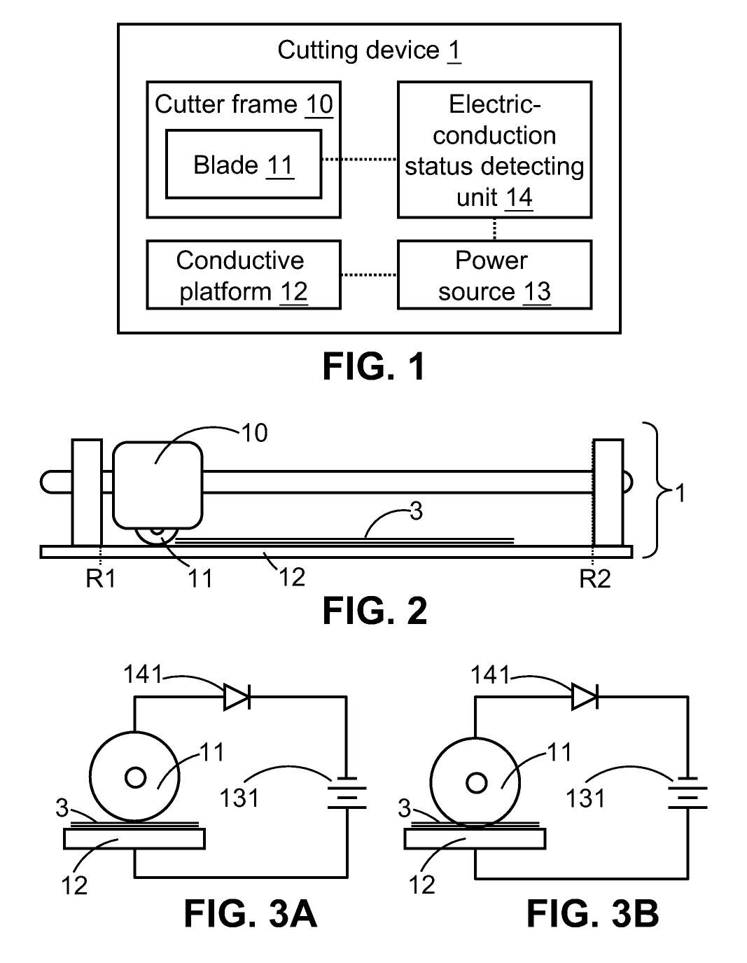

FIG. 1 is a schematic functional block diagram of a cutting device according to a first preferred embodiment of the present invention. FIG. 2 is a schematic side view of the cutting device shown in FIG. 1. Please refer to FIG. 1 and FIG. 2. The cutting device 1 principally comprises a cutter frame 10, a blade 11, a conductive platform 12, a power source 13 and an electric-conduction status detecting unit 14. The cutter frame 10 is movable between a first turning point R1 and a second turning point R2. The blade 11 is mounted on the cutter frame 10 and a portion of the blade 11 is protruded from the bottom of the cutter frame 10. The conductive platform 12 is disposed under the cutter frame 10 for supporting the objects 3 (such as papers or photographs) to be cut by the blade 11. As the cutter frame 10 is moved between the first turning point R1 and the second turning point R2, the blade 11 which is protruded from the bottom of the cutter frame 10 will cut off the objects 3 on the conductive platform 12. The power source 13 includes a first terminal coupled to the blade 11 and a second terminal coupled to the conductive platform 12. The electric-conduction status detecting unit 14 is inserted into a closed loop defined by the blade 11, the conductive platform 12 and the power source 13 so as to detect whether the blade 11 and the conductive platform 12 are electrically connected with each other or not.

FIG. 3A and FIG. 3B are schematic circuit diagrams illustrating a method for detecting whether an object is completely cut off by means of a light emitting diode. In this embodiment, the cutting device 1 is a manual cutting device. The power source 13 includes for example a DC power-supplying device such as a battery 131. The positive terminal of the battery 131 is coupled to the conductive platform 12. The negative terminal of the battery 131 is coupled to the blade 11 through the electric-conduction status detecting unit 14. In this embodiment, the electric-conduction status detecting unit 14 includes a light emitting diode 141. The light emitting diode 141 is inserted into a closed loop defined by the blade 11, the conductive platform 12 and the power source 13. In a case that the objects 3 have not been completely cut off, as shown in FIG. 3A, the blade 11 is not electrically connected to the conductive platform 12 and thus no light is emitted from the light emitting diode 141. Whereas, if the objects 3 are completely cut off, as shown in FIG. 3B, the blade 11 is electrically connected to the conductive platform 12. Under this circumstance, the light emitting diode 141 emits an optical signal. In other words, if the optical signals are continuously generated during the cutter frame 10 is moved from the first turning point R1 to the second turning point R2 (or from the second turning point R2 to the first turning point R1), the user may assure that the objects 3 have been completely cut off by the blade 11 and the cutting operation is completed.

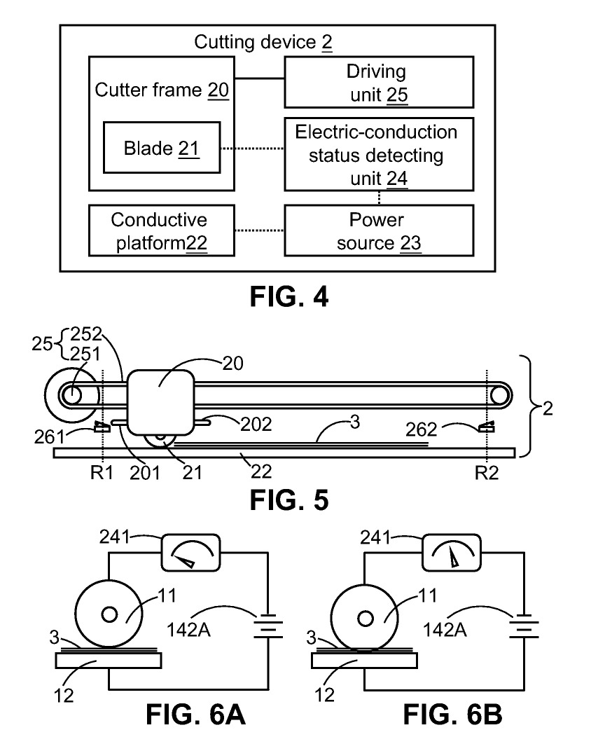

FIG. 4 is a schematic functional block diagram of a cutting device according to a second preferred embodiment of the present invention. FIG. 5 is a schematic side view of the cutting device shown in FIG. 4. Please refer to FIGS. 4 and 5. The cutting device 2 principally comprises a cutter frame 20, a blade 21, a conductive platform 22, a power source 23, an electric-conduction status detecting unit 24 and a driving unit 25. The blade 21 is mounted on the cutter frame 20 and a portion of the blade 21 is protruded from the bottom of the cutter frame 20. The conductive platform 22 is disposed under the cutter frame 20 for supporting the objects 3 (such as papers or photographs) to be cut by the blade 21. The driving unit 25 includes a motor 251 and a belt 252 for driving the cutter frame 20 to move between a first turning point R1 and a second turning point R2. As the cutter frame 20 is moved between the first turning point R1 and the second turning point R2, the blade 21 which is protruded from the bottom of the cutter frame 20 will cut off the objects 3 on the conductive platform 22. The power source 23 includes a first terminal coupled to the blade 21 and a second terminal coupled to the conductive platform 22. The electric-conduction status detecting unit 24 is inserted into a closed loop defined by the blade 21, the conductive platform 22 and the power source 23 so as to detect whether the blade 21 and the conductive platform 22 are electrically connected with each other or not.

FIG. 6A and FIG. 6B are schematic circuit diagrams illustrating a method for detecting whether an object is completely cut off by means of a current detector. In this embodiment, the cutting device 2 is an automatic cutting device. The power source 23 includes for example a DC power-supplying device such as a battery 231. The positive terminal of the battery 231 is coupled to the conductive platform 22. The negative terminal of the battery 231 is coupled to the blade 21 through the electric-conduction status detecting unit 24. In this embodiment, the electric-conduction status detecting unit 24 includes a current detector 241. The current detector 241 is inserted into a closed loop defined by the blade 21, the conductive platform 22 and the power source 23. In a case that the objects 3 have not been completely cut off, as shown in FIG. 6A, the blade 21 is not electrically connected to the conductive platform 22 and thus no current flowing through the blade 21 and the conductive platform 22 is detected by the current detector 241. Whereas, if the objects 3 are completely cut off, as shown in FIG. 6B, the blade 21 is electrically connected to the conductive platform 22. Under this circumstance, a current flowing through the blade 21 and the conductive platform 22 is detected by the current detector 241. In other words, if the current flowing through the blade 21 and the conductive platform 22 is continuously detected during the cutter frame 20 is moved from the first turning point R1 to the second turning point R2 (or from the second turning point R2 to the first turning point R1), it is assured that the objects 3 have been completely cut off by the blade 21 and thus the cutting operation will be automatically interrupted.

In the first and second embodiments of the cutting devices 1 and 3, the method of discriminating whether the objects have been completely cut off by the blades 11 and 21 are based on the insulator properties of the objects (such as papers or photographs) and the conductor properties of the blades 11, 21 and the conductive platforms 12, 22. Both terminals of the power sources 13 and 23 are respectively coupled to the blades 11, 21 and the conductive platforms 12, 22. In a case that the blades 11, 21 cut off the objects 3 and are contacted with the conductive platforms 12, 22, the electric-conduction status detecting unit 24 detect electrical conduction between the blades 11, 21 and the conductive platforms 12, 22 and thus a notification signal is asserted to either notify the user that the cutting operation is completed or automatically interrupt the cutting operation.

In addition to the function of detecting whether the objects 3 are completely cut off, the cutting devices 1 and 2 can discriminate whether the objects 3 are “completely” sectioned into at least two parts but the blades 11 and 12. If the blades 11, 21 and the conductive platforms 12, 22 are continuously electrically connected to each other during the cutter frame 20 is moved from the first turning point R1 to the second turning point R2 (or from the second turning point R2 to the first turning point R1), it is assured that the objects 3 are completely sectioned into at least two parts.

Hereinafter, the principle of discriminating whether the objects 3 are completely sectioned into at least two parts will be illustrated with reference to FIG. 5. Please refer to FIG. 5 again. The cutting device 2 of the second preferred embodiment further includes a first position detector 261 at the first turning point R1 and a second position detector 262 at the second turning point R2. When the cutter frame 20 of the cutting device 2 is moved to the first turning point R1, the first position detector 261 detects the cutter frame 20 and asserts a first sensing signal to the driving unit 25. In response to the first sensing signal, the driving unit 25 drives the cutter frame 20 to move from the first turning point R1 toward the second turning point R2. When the cutter frame 20 is moved to the second turning point R2, the second position detector 262 detects the cutter frame 20 and asserts a second sensing signal to the driving unit 25. In response to the second sensing signal, the driving unit 25 drives the cutter frame 20 to move from the second turning point R2 toward the first turning point R1. By means of the first position detector 261 and the second position detector 262, the reciprocating motion between the first turning point R1 and the second turning point R2 of the cutter frame 20 is precisely controlled. Until the electric-conduction status detecting unit 24 detect continuously electrical conduction between the blade 21 and the conductive platform 22 during the cutter frame 20 is moved from the first turning point R1 to the second turning point R2 (or from the second turning point R2 to the first turning point R1), the cutting operation of the cutting device 2 is automatically interrupted. In this embodiment, the first position detector 261 and the second position detector 262 are limit switches and the cutter frame 20 has piston rods 201 and 202 corresponding to the first position detector 261 and the second position detector 262. The first position detector 261 and the second position detector 262 are respectively triggered by the piston rods 201 and 202 to generate the first and second sensing signals.

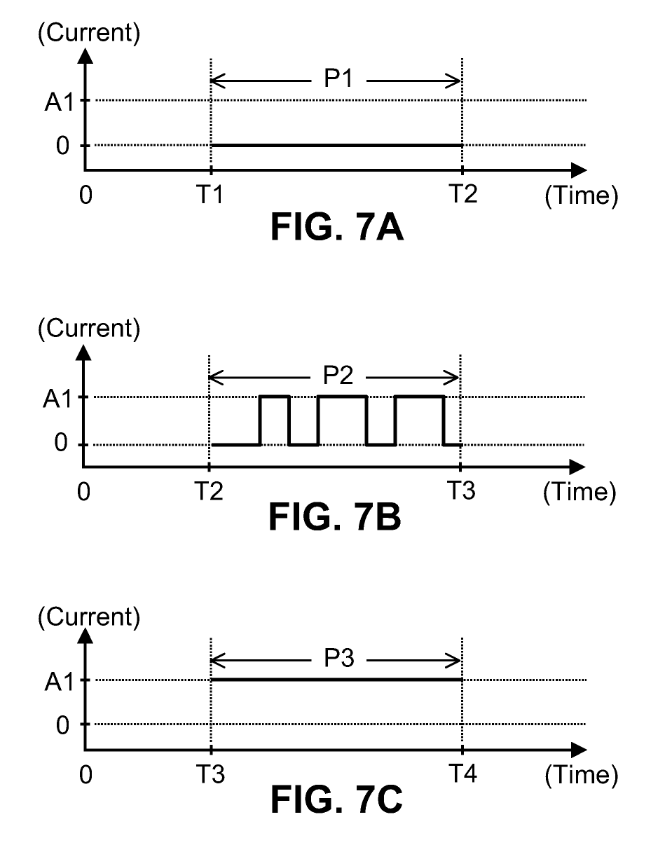

FIGS. 7A, 7B and 7C are timing diagrams illustrating current measured by the current detector in the second preferred embodiment of the present invention. The use of the current detector 241 to detect the current flowing through the blade 21 and the conductive platform 22 allows to realize whether the objects 3 are completely cut off by the blade 21 or not. In this embodiment, both terminals of the power source 23 of the cutting device 2 are respectively coupled to the blade 21 and the conductive platform 22. The first turning point R1 and the second turning point R2 are defined by the first position detector 261 and the second position detector 262 of the cutting device 2, respectively. By detecting whether the blade 21 is electrically connected to the conductive platform 22 during the cutter frame 20 is moved from the first turning point R1 to the second turning point R2 (or from the second turning point R2 to the first turning point R1), it is easy to realize whether the objects 3 have been completely cut off.

Please refer to FIG. 7A. During the time interval P1 of moving the cutter frame 20 from the first turning point R1 (at the time spot T1) to the second turning point R2 (at the time spot T2), no current flowing through the blade 21 and the conductive platform 22 is detected by the current detector 241. Meanwhile, the cutting device 2 discriminates that the objects 3 have not been completely cut off by the blade 21. As a consequence, the driving unit 25 drives the cutter frame 20 to move from the second turning point R2 toward the first turning point R1.

Please refer to FIG. 7B. During the time interval P2 of moving the cutter frame 20 from the second turning point R2 (at the time spot T2) to the first turning point R1 (at the time spot T3), an intermittent current A1 flowing through the blade 21 and the conductive platform 22 is detected by the current detector 241. Meanwhile, the cutting device 2 discriminates that the objects 3 have been partially cut off by the blade 21. As a consequence, the driving unit 25 drives the cutter frame 20 to move from the first turning point R1 toward the second turning point R2.

Please refer to FIG. 7C. During the time interval P3 of moving the cutter frame 20 from the first turning point R1 (at the time spot T3) to the second turning point R2 (at the time spot T4), a continuous current A1 flowing through the blade 21 and the conductive platform 22 is detected by the current detector 241. Since continuous electric conduction between the blade 21 and the conductive platform 22 is rendered during the time interval P3, the cutting device 2 discriminates that the objects 3 have been completely cut off by the blade 21. As a consequence, the cutter frame 20 stays at the first turning point R1 and the cutting operation is interrupted.

It is noted that, however, those skilled in the art will readily observe that numerous modifications and alterations may be made while retaining the teachings of the invention. For example, the electric-conduction status detecting unit may include a voltage detector. In a case that the objects are not completely cut off by the blade, a first voltage is detected by the voltage detector. In another case that the objects are cut off by the blade and the blade is contacted with the conductive platform, a second voltage is detected by the voltage detector. If the second voltage is continuously detected by the voltage detector during the cutter frame is moved from the first turning point R1 to the second turning point R2 (or from the second turning point R2 to the first turning point R1), the cutting device discriminates that the objects have been completely cut off by the blade and thus the cutting operation is automatically interrupted.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A cutting device comprising:
a cutter frame movable between a first returning point and a second returning point;
a blade mounted on said cutter frame and partially protruded from a bottom of said cutter frame;
a conductive platform disposed under aid cutter frame for supporting an object to be cut by said blade;
a power source having a first terminal coupled to said blade and a second terminal coupled to said conductive platform; and
an electric-conduction status detecting unit for detecting whether said blade and said conductive platform are electrically connected to each other.

2. The cutting device according to claim 1 wherein said electric-conduction status detecting unit includes a current detector for detecting a current when said blade is contacted with said conductive platform.

3. The cutting device according to claim 1 wherein said electric-conduction status detecting unit includes a light emitting diode for asserting an optical signal when said blade is contacted with said conductive platform.

4. The cutting device according to claim 1 wherein said electric-conduction status detecting unit includes a voltage detector for detecting a first voltage when said object is not completely cut off by said blade or detecting a second voltage when said blade is contacted with said conductive platform.

5. The cutting device according to claim 1 further comprising a driving unit for driving said cutter frame.

6. The cutting device according to claim 5 further comprising a first position detector at said first returning point, wherein said first position detector asserts a first sensing signal to said driving unit when said cutter frame is located at said first returning point, and said driving unit drives said cutter frame to move from said first returning point toward said second returning point in response to said first sensing signal.

7. The cutting device according to claim 6 wherein said first position detector is a limit switch.

8. The cutting device according to claim 6 further comprising a second position detector at said second returning point, wherein said second position detector asserts a second sensing signal to said driving unit when said cutter frame is located at said second returning point, and said driving unit drives said cutter frame to move from said second returning point toward said first returning point in response to said second sensing signal.

9. The cutting device according to claim 8 wherein said second position detector is a limit switch.

10. A method for detecting whether an object is completely cut of by a cutting device, said cutting device comprising a cutter frame, a blade mounted on said cutter frame and a conductive platform for supporting an object to be cut by said blade, said cutter frame is movable between a first returning point and a second returning point to have said blade cut off said object, said method comprising steps:
coupling a first terminal of a power source to said blade;
coupling a second terminal of a power source to said conductive platform;
detecting whether said blade is electrically connected with said conductive platform; and
discriminating that said object has been completely cut off if said blade is continuously electrically connected with said conductive platform during said cutter frame is moved from said first returning point to said second returning point.

11. The method according to claim 10 further comprising a step of discriminating that said object has not been completely cut off if said blade is not continuously electrically connected with said conductive platform during said cutter frame is moved from said first returning point to said second returning point.

12. The method according to claim 10 wherein whether the step of detecting whether said blade is electrically connected with said conductive platform is implemented by an electric-conduction status detecting unit.

13. The method according to claim 12 wherein said electric-conduction status detecting unit includes a current detector for detecting a current when said blade is contacted with said conductive platform.

14. The method according to claim 12 wherein said electric-conduction status detecting unit includes a light emitting diode for asserting an optical signal when said blade is contacted with said conductive platform.

15. The method according to claim 12 wherein said electric-conduction status detecting unit includes a voltage detector for detecting a first voltage when said object is not completely cut off by said blade or detecting a second voltage when said blade is contacted with said conductive platform.
